(19) United States
(12) Patent Application Publication
(10) Pub. No.: US 2026/0111165 A1
(43) Pub. Date: Apr. 23, 2026

(54) PERSONALIZED AUDIO IN A SHARED VIEWING ENVIRONMENT

(71) Applicant: Roku, Inc., San Jose, CA (US)

(72) Inventors: David Lee Stern, Los Gatos, CA (US); Sunil Ramesh, Saratoga, CA (US); Juhie Vijayvargiya, Los Angeles, CA (US); Michael Patrick Cutter, Golden, CO (US); Gregory Garner, Key Colony Beach, FL (US); Soren Riise, Templeton, CA (US); Dustin Verhoeve, Santa Cruz, CA (US); Patrick Brouillette, Tempe, AZ (US)

(21) Appl. No.: 18/919,190

(22) Filed: Oct. 17, 2024

(51) Int. Cl. G06F 3/16; H04N 21/454; H04N 21/81

(52) U.S. Cl. CPC G06F 3/165; H04N 21/454; H04N 21/8106

(57) ABSTRACT

Aspects of the disclosed technology provide solutions for customizing audio streams for individual users. An example process can include steps for receiving an audio stream, establishing a connection with a first audio device associated with a first user, establishing a connection with a second audio device associated with a second user, and delivering a first segment of the audio stream to the first audio device based on user preferences associated with the first user. The process can further include steps for delivering a second segment of the audio stream to the second audio device based on user preferences associated with the second user. Systems and machine-readable media are also provided.

### BACKGROUND

### Field

This disclosure is generally directed to customized audio streams and more particularly, to solutions for customizing individual user audio streams in shared viewing environments.

### SUMMARY

Provided herein are system, apparatus, article of manufacture, method and/or computer program product embodiments, and/or combinations and sub-combinations thereof, for generating media content.

In some aspects, a system is provided for customizing individual user audio streams in a shared viewing environment. The system can include one or more memories and at least one processor coupled to at least one of the one or more memories and configured to receive an audio stream, establish a connection with a first audio device associated with a first user, establish a connection with a second audio device associated with a second user, and deliver a first segment of the audio stream to the first audio device based on user preferences associated with the first user. In some aspects, the processor can be further configured to deliver a second segment of the audio stream to the second audio device based on user preferences associated with the second user.

In some aspects, a method is provided for customizing individual user audio streams in a shared viewing environment. The method can include steps for receiving an audio stream, establishing a connection with a first audio device associated with a first user, establishing a connection with a second audio device associated with a second user, and delivering a first segment of the audio stream to the first audio device based on user preferences associated with the first user. In some aspects, the method can further include steps for delivering a second segment of the audio stream to the second audio device based on user preferences associated with the second user.

In some aspects, a non-transitory computer-readable medium is provided for customizing individual user audio streams in a shared viewing environment. The non-transitory computer-readable medium can have instructions stored thereon that, when executed by at least one computing device, cause the at least one computing device to receive an audio stream, establish a connection with a first audio device associated with a first user, establish a connection with a second audio device associated with a second user, and deliver a first segment of the audio stream to the first audio device based on user preferences associated with the first user. In some aspects, the instructions can be further configured to deliver a second segment of the audio stream to the second audio device based on user preferences associated with the second user.

### BRIEF DESCRIPTION OF THE FIGURES

The accompanying drawings are incorporated herein and form a part of the specification.

FIG. 1 illustrates a block diagram of a multimedia environment, according to some examples of the present disclosure.

FIG. 2 illustrates a block diagram of a streaming media device, according to some examples of the present disclosure.

FIG. 3 is a diagram illustrating an example system environment that can be used to customize individual user audio streams in a shared viewing environment, according to some examples of the present disclosure.

FIG. 4 is a diagram illustrating an example system that can be used to manage/parse user-customized audio streams, according to some examples of the present disclosure.

FIG. 5 illustrates an example process for authenticating a user and matching the user with a corresponding audio delivery device, according to some examples of the present disclosure.

FIG. 6 illustrates an example process for authenticating users for access to user profile information to facilitate delivery of customized audio streams, according to some examples of the present disclosure.

FIG. 7 illustrates steps of an example process for customizing individual user audio streams, according to some examples of the present disclosure.

FIG. 8 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Users can generally access and consume videos using client devices such as, for example and without limitation, smart phones, set-top boxes, desktop computers, laptop computers, tablet computers, televisions (TVs), IPTV receivers, media devices, monitors, projectors, smart wearable devices (e.g., smart watches, smart glasses, head-mounted displays (HMDs), etc.), appliances, and Internet-of-Things (IoT) devices, among others. Consumed media can include, for example, live video content broadcast by a content server(s) to the client devices, pre-recorded video content available to the client devices on-demand, streaming video content, etc. In some instances, video content can be generated by one or more IoT devices, such as security cameras, and viewed by a user using one or more client devices.

In typical shared viewing environments, such as when multiple users watch TV together, the users are limited to experiencing a single audio stream. This restriction presents challenges in accommodating diverse user needs and preferences. For instance, one viewer may prefer to listen to the original language audio track, while another may prefer a dubbed version or subtitles in a different language for comprehension. Additionally, accessibility needs such as audio descriptions for the visually impaired or sign language interpretation for the hearing impaired cannot be simultaneously catered to through a single audio output. The lack of individualized audio options restricts the viewing experience for shared user viewing scenarios, preventing a customized and inclusive experience for all viewers. Therefore, there is a need for a system that allows multiple users to receive customized audio content, tailored to their individual preferences and requirements, while watching the same visual content on a shared media device, such as a shared television display.

Aspects of the disclosed technology address the foregoing limitations by providing solutions for delivering customized audio content to multiple viewers that are consuming the same content by implementing a system that allows individualized audio streams for each user. In some implementations, each individual user can be identified through a setup or user registration process, after which the available audio content can be parsed and separately transmitted to each user, e.g., to create customized audio streams tailored to each individual's needs. These streams can include different language tracks, audio descriptions, volume levels, frequency profiles, and/or other personalization enhancements.

Audio delivery can be provided using individual audio playback devices, such as conduction headsets that correspond to each registered user or viewer. These devices ensure that each user receives their specific audio stream without interference from others, providing a personalized and inclusive viewing experience. This solution not only enhances the viewing experience by accommodating diverse user preferences and requirements but also promotes accessibility for viewers with special needs. As such, customized audio streams can be used to enable a variety of features, including high-granularity mature-language filtering to apply content filters based on user age restrictions or parental settings, for example, to ensure that mature or inappropriate language is effectively screened out for younger viewers. Customized audio streams can also be used to provide multi-language audio support for common viewers in the shared viewing environment. For example, customized audio streams can correspond with distinct language preferences to provide multi (or mixed) language support. In some implementations, customized audio streams can be used to support viewers with visual impairments, for example, by providing audio description tracks, for select users, that can provide narration of on-screen actions, dialogues, and/or other visual details. In other implementations, customized audio feeds may be used to provide personalized advertising content, for example, that is provided on a user-by-user basis depending on user preference, user profile data and viewing habits, and/or user demographic information, etc. The customization of ad delivery can be used to enhance advertisement relevance and improve user engagement by better aligning promotional content with user interests and demographic characteristics.

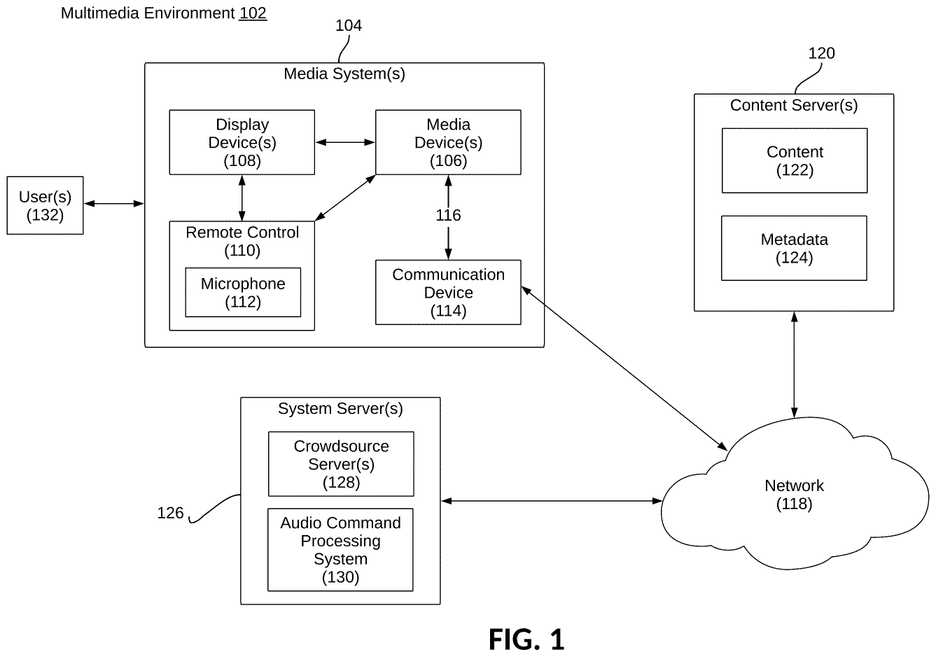

Various embodiments, examples, and aspects of this disclosure may be implemented using and/or may be part of a multimedia environment 102 shown in FIG. 1. It is noted, however, that multimedia environment 102 is provided solely for illustrative purposes and is not limiting. Examples and embodiments of this disclosure may be implemented using, and/or may be part of, environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, television, tablet, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some examples, media device 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as WiFi) and/or wired connections.

In various examples, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, laptop computer, smartphone, wearable, on-screen controls, integrated control buttons, audio controls, or any combination thereof, to name just a few examples. In some examples, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels or sources). Although only one content server 120 is shown in FIG. 1, in practice, the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, targeted media content, software, and/or any other content or data objects in electronic form. In some aspects, content 122 may include on-demand content, free ad-supported TV (FAST); advertising-based video on demand (AVOD); linear content, non-linear content, etc. In some cases, content 122 may be referred to herein as media content or media content item(s).

In some examples, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining to or relating to the content 122. Metadata 124 may also or alternatively include one or more indexes of content 122, such as but not limited to a trick mode index. In one illustrative example, metadata 124 may include one or more manifest files (e.g., XML files) that include metadata that is associated with a video stream such as, for instance, a dynamic adaptive streaming over HTTP (DASH) media stream or a HTTP live streaming (HLS) media stream.

In some examples, the content server 120 or the media device 106 can process content 122 and/or metadata 124 to identify portions of content 122 that include targeted media content. As used herein, targeted media content may include any type of media content (e.g., video content, image content, audio content, text content, etc.) that promotes or is otherwise associated with a product, service, brand, and/or event. In some configurations, content server 120 or media device 106 can identify targeted media content within content 122 based on metadata 124. For instance, metadata 124 can be used to derive one or more playback properties associated with content 122 such as playback duration; content server address(es) (e.g., uniform resource locator(s) URLs); closed-captioning content; encryption status; etc. In some cases, media device 106 or content sever 120 can use one or more of the playback properties (e.g., based on metadata 124) to identify portions of content 122 that correspond to targeted media content.

In some examples, the content server 120 or the media device 106 can process media content segments to extract features and information, such as contextual information, from the media content segments and classify the media content segments based on the extracted features and information. In some examples, the content server 120 or the media device 106 can determine and/or extract information (e.g., contextual information, content information and/or attributes, segment characteristics, etc.) about one or more segments of media content, and use the information to categorize the one or more segments of the media content. In some configurations, the content server 120 or the media device 106 can use the extracted information (e.g., contextual information) to classify portions of content 122 as targeted media content.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126. In some aspects, system servers 126 can store information associated with users 132 (e.g., user profile data, user preferences, historical data, etc.).

The media devices 106 may exist in thousands or millions of media systems 104. Accordingly, the media devices 106 may lend themselves to crowdsourcing embodiments and, thus, the system servers 126 may include one or more crowdsource servers 128. For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 128 may operate to cause closed captioning to be automatically turned on and/or off during future streaming of the movie.

The system servers 126 may also include an audio command processing system 130. As noted above, the remote control 110 may include a microphone 112. The microphone 112 may receive audio data from users 132 (as well as other sources, such as the display device 108). In some examples, the media device 106 may be audio responsive, and the audio data may represent verbal commands from the user 132 to control the media device 106 as well as other components in the media system 104, such as the display device 108.

In some examples, the audio data received by the microphone 112 in the remote control 110 is transferred to the media device 106, which is then forwarded to the audio command processing system 130 in the system servers 126. The audio command processing system 130 may operate to process and analyze the received audio data to recognize the user 132's verbal command. The audio command processing system 130 may then forward the verbal command back to the media device 106 for processing.

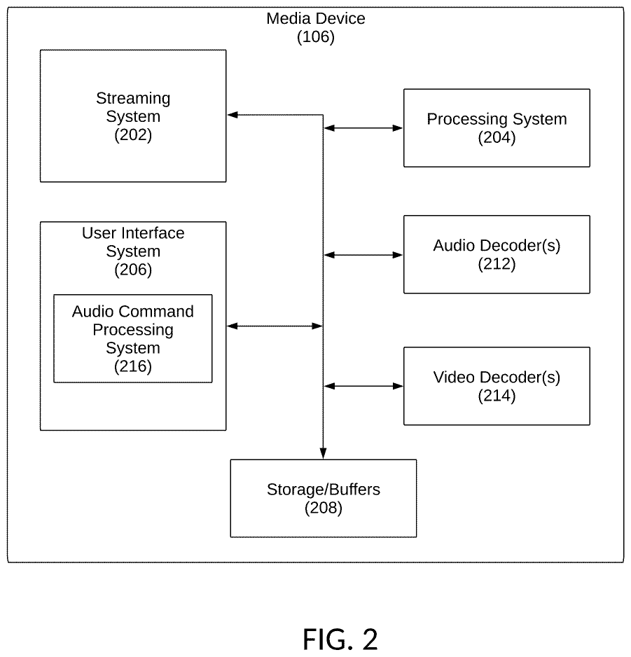

In some examples, the audio data may be alternatively or additionally processed and analyzed by an audio command processing system 216 in the media device 106 (see FIG. 2). The media device 106 and the system servers 126 may then cooperate to pick one of the verbal commands to process (either the verbal command recognized by the audio command processing system 130 in the system servers 126, or the verbal command recognized by the audio command processing system 216 in the media device 106).

FIG. 2 illustrates a block diagram of an example media device 106, according to some aspects of the present technology. Media device 106 may include a streaming system 202, processing system 204, storage/buffers 208, and user interface module 206. As described above, the user interface module 206 may include the audio command processing system 216.

The media device 106 may also include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples. The media device 106 can implement other applicable decoders, such as a closed caption decoder.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to, H.263, H.264, H.265, VVC (also referred to as H.266), AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some examples, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming system 202 of the media device 106 may request the selected content from the content server(s) 120 over the network 118. The content server(s) 120 may transmit the requested content to the streaming system 202. The media device 106 may transmit the received content to the display device 108 for playback to the user 132.

In streaming examples, the streaming system 202 may transmit the content to the display device 108 in real time or near real time as it receives such content from the content server(s) 120. In non-streaming examples, the media device 106 may store the content received from content server(s) 120 in storage/buffers 208 for later playback on display device 108.

Referring to FIG. 1, content server(s) 120, system servers 126, and/or media devices 106 can be configured to perform applicable functions related to customizing content 122. For example, users 132 can provide an input (e.g., via display devices 108, remote control 110, and/or media device(s) 106) indicative of a preferred level of exposure to targeted media content (e.g., video, audio, image, text, etc. that is associated with a product, service, brand, and/or event, such as a commercial). In some cases, content server(s) 120, system server(s) 126, and/or media devices 106 can implement one or more algorithms (e.g., heuristic-based algorithms, rule-based algorithms, machine learning models, etc.) that can be used process the user input and generate a customized targeted media content experience for the user. The customized targeted media content experience can include a customized amount of targeted media content, a customized frequency in presentation of targeted media content, a customized type of targeted media content, any other type of modification to the presentation of content 122, and/or any combination thereof.

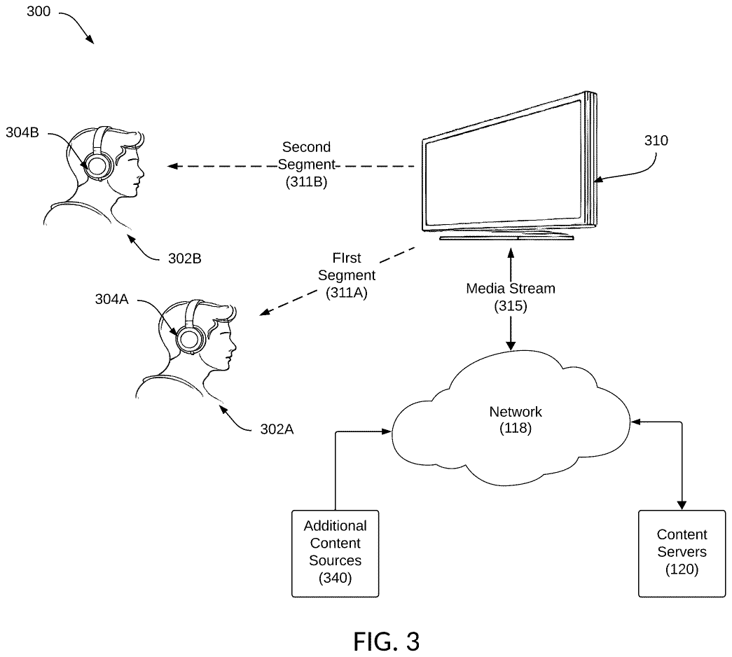

FIG. 3 is a diagram illustrating an example system environment 300 in which customized individual user audio streams can be provided to multiple users/viewers 302, e.g., including user 302A and user 302B. It is understood that a greater number of viewers may be present in environment 300, without departing from the scope of the disclosed technology.

In practice, users 302 can consume media delivered to media device 310 via network 118. Media content can be transmitted from one or more content servers 120 or other content sources 340 to media device 310 in the form of one or more data streams, e.g., media stream 315. As discussed above, content servers 120 can be used to provide various types of multimedia content including but not limited to movies, music, sports, and other forms of entertainment content. However, it is understood that media information received from content servers 120 and/or additional content sources 340 can contain multimedia information for virtually any content type. By way of example, additional content sources 340 can include one or more cameras, or security systems, such as a connected doorbell device, or baby monitor, or the like. As such, additional content sources 340 can include any device, including IoT devices, configured to provide data (media stream 315) to media device 310.

The media stream/s 315 received by media device 310 can include audio information that corresponds to video content provided on a display of media device 310. By way of example, audio information can include content dialogue, dubbing or other voice-over information, and/or audible metadata information for example, that provides audible descriptions of certain portions of on-screen content for visually impaired viewers.

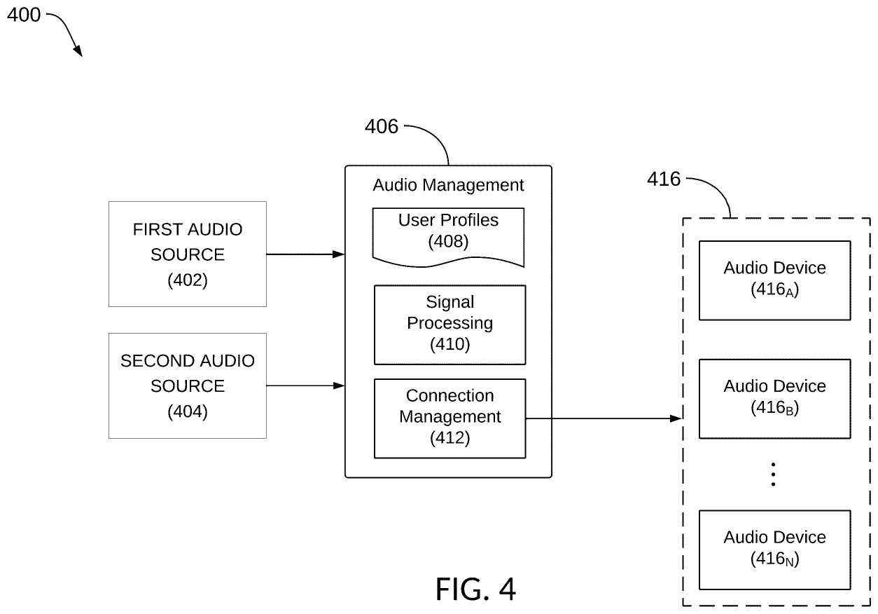

Media device 310 can be configured to identify users 302 and parse audio information into customized audio streams or segments 311 that correspond with each individual user (302A, 302B). As illustrated in environment 300, user 302A receives first audio segment 311A, and user 302B receives second audio segment 311B. Customized audio streams can be delivered to an audio playback device, such as a headset 304, that is associated with the receiving user. In the illustrated example, user 302A can receive a first audio segment 311A at playback device 304A, and user 302B can receive a second audio segment 311B at playback device 304B. Audio playback devices 304 can be, or may include, any of a variety of devices, including but not limited to conduction headsets, in-ear headphones, and/or over-ear headphones, etc. As such, communication channels between playback devices 304 and media device 310 may also use a variety protocols or connection means, including wired or wireless communications. Further details regarding signal processing and connection management performed by media device 310 are discussed in relation to FIG. 4, below.

FIG. 4 is a diagram illustrating an example system 400 that can be used to manage/parse user-customized audio streams. System 400 includes one or more audio sources, such as a first audio source 402 and a second audio source 404. As discussed above, audio sources (402, 404) can be (or may include) one or more content servers (e.g., content servers 120), or IoT devices, such as network connected cameras (e.g., additional content sources 340). It is understood that additional (or different) audio sources than those illustrated can be used, without departing from the scope of the disclosed technology.

Audio sources (402, 404) can provide audio information (media streams) to a media device (e.g., media device 310) that includes an audio management module 406. Audio management module 406 can include, or can access a variety of information and perform a variety of functions, including but not limited to accessing user profile data (408) and performing necessary signal processing (410) to parse audio streams into user customized segments. Audio management module 406 can also include a connection management module 412 that manages wired and/or wireless connections with any number of audio devices 416, each of which may be associated with a specific user.

In practice, one or more audios streams can be received by audio management module 406 (e.g., from a first source 402 and/or a second source 404) and parsed into user-specific audio segments. Further to the example of environment 300, signal processing module 410 may be configured to parse the received audio data into a first audio segment (e.g., 311A) for delivery to a first user (e.g., user 302A), and a second audio segment (e.g., 311B) for delivery to a second user (e.g., user 302B). The signal processing module 410 can handle the signal processing necessary to synchronize the delivery of audio content, in either audio segment, with the corresponding visual media that is consumed by the users. For example, audio description of on-screen events or other information related to the displayed content may be provided at a timing and pace that corresponds with the related visual display.

In many instances, the customized audio segments may be determined based on user preferences stored as user profile data, e.g., in one or more user profiles 408. User profiles 408 can include, but are not limited to, information regarding user language preferences, content filters (e.g., mature content filters), user demographic information, user watch history information, user audio preferences, and/or preferences for audio source prioritization. Based on user profiles 408, signal processing can be performed (e.g., by signal processing module 410) to alter and/or mix audio streams received from one or more sources. The appropriate audio stream (audio segment) can then be transmitted to the associated audio device 416 associated with a corresponding user via connection management module 413.

By way of example, first audio source 402 can be a content server configured to deliver entertainment content (e.g., movies/television), whereas second audio source 404 may provide audio feeds from a baby monitor. User profile information for a first user (e.g., a mother) may indicate that audio data from second audio source 404 (e.g., a baby monitor) should be prioritized over audio content provided by first audio source 402. Additionally, user profile information for a second user (e.g., a child) may indicate that mature content should be filtered from audio streams (or audio segments) provided to the second user, and that no feeds from second audio source 404 should be transmitted. In this example, audio segments provided to the first user may include audio data from the baby monitor, whereas audio segments provided to the second user may filter (or replace) the occurrence of certain words, phrases, or sounds, before delivery to an audio device associated with the small child.

User profiles 408 can be used to customize the delivery of advertising content, for example, that is provided on a user-by-user basis depending on user preferences and viewing habits, and/or user demographic information, etc. The customization of ad delivery can be used to enhance advertisement relevance and improve user engagement by better aligning promotional content with user interests and demographic characteristics. By way of example, different audio soundtracks may be delivered to different users viewing the same product advertisements on a common display (e.g., media device 310), based on each user's associated profile.

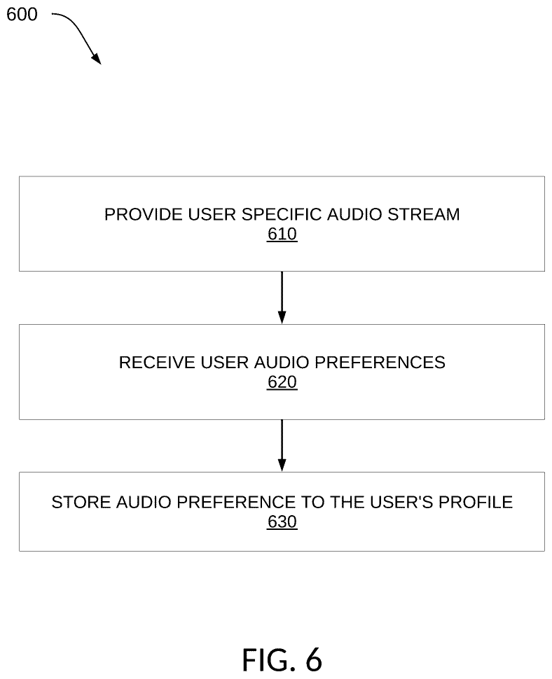

User profiles 408 may also include information indicating relative audio preferences, such as profiles for how a user prefers to listen to certain types of audio content. By way of example, profile information may specify that certain audible frequencies are to be enhanced for music content, while different frequencies may be enhanced for narrative or dialogue content, e.g., to make music more enjoyable for those of different hearing abilities, or to make audio comprehension easier for those with limited hearing. In some instances, audio preferences may be imported from a third-party source, such as by importing audio frequency settings data from an audiologist or another third-party system. Further details regarding a process for configuring customized user audio preference are provided in further detail with respect to FIG. 6, below.

Audio preferences can also be associated with a specific audio delivery device, system-wide audio configuration, and/or environment/location. For example, different audio playback devices such as different headset types or models may be associated with certain audio preferences. By way of example, a user may wish to amplify (or attenuate) certain frequencies on an audio device with noise-canceling capabilities but wish to attenuate (or amplify) different frequencies on a device without noise-canceling capabilities. Similarly, user preference information may indicate a user's desire to implement certain volume controls, such as limits on maximum (or minimum) volume, depending on location, etc.

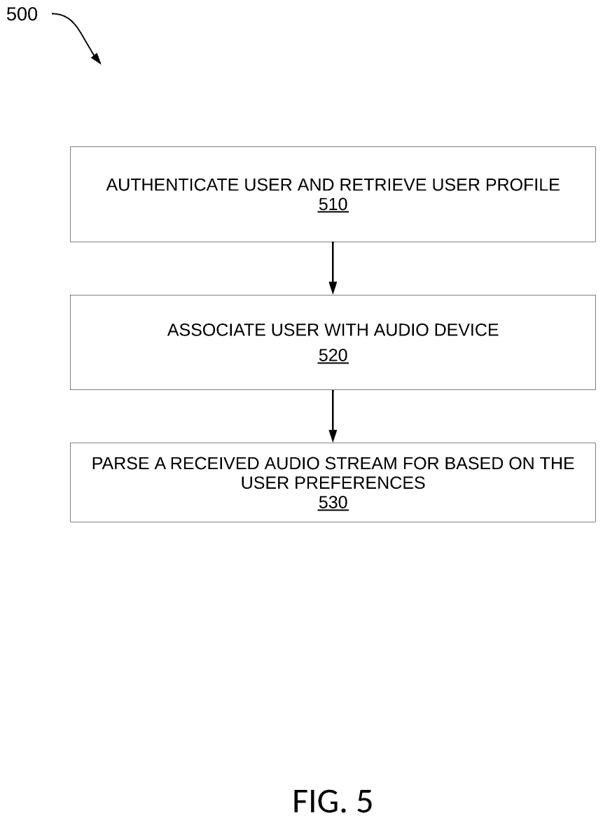

FIG. 5 illustrates an example process 500 for authenticating a user and matching the user with a corresponding audio delivery device, according to some examples of the present disclosure.

At step 502, the process 500 includes authenticating a user and retrieving the user's profile. User authentication can be performed in a variety of ways, depending on the desired implementation. User authentication may be performed with the aid of a personal mobile device (such as a smart phone), that can be used to associate the user's profile with a media device in a share viewing environment. By way of example, a user's smartphone may be used to read a QR code displayed on the display device to authenticate the user, and to retrieve the user's profile information.

At step 520, process 500 includes associating the user with a desired personal audio device, such as a headset. In some instances, audio device selection may be facilitated through the display of a unique identifier on the display, which corresponds to the user's audio device. In other aspects, device associations may be indicated using an audible indicator, such as through playback of a specific sound on the selected audio device, or through a visual indicator (e.g., light or LED) on the audio device. In some instances, audio devices may be personal to the user and may be automatically identified based on a wireless connection profile, such as a Bluetooth ID, or the like.

At step 530, the process 500 includes parsing received audio streams based on the selected playback device and associated user preferences.

FIG. 6 illustrates an example process 600 for calibrating user-specific audio settings, according to some examples of the present disclosure. At step 610, process 600 includes providing a user specific audio stream, e.g., for playback to the user via an associate audio device. In some instances, the audio stream may include a playback sequence that varies in volume and frequency range, for example, to allow the user to sample/experience audio playback for a range of audio outputs.

At step 620, process 600 includes receiving user audio preference information, for example, indicating changes to frequencies or volume levels that match the user's preferences. In some aspects, user audio preferences may be communicated with the aid of a smartphone and application (app) that enables the user to adjust frequency/volume parameters (e.g., a using an equalizer display).

At step 630, the process 600 includes storing the audio preferences to the user's profile. Audio preference information can enable the user to conveniently load audio preference information, irrespective of the viewing environment. As discussed above, audio preferences can be associated with a particular playback device and/or location, so that the user's audible experience can be standardized across devices or in certain viewing environments.

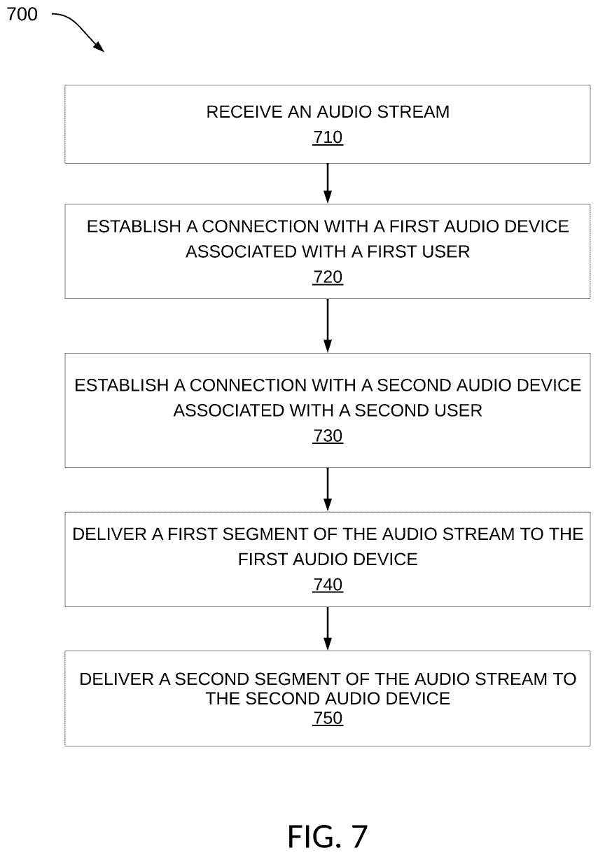

FIG. 7 illustrates steps of an example process 700 for customizing individual user audio streams, according to some examples of the present disclosure.

At step 710, the process 700 includes receiving at least one audio stream. The audio stream can be received as part of a media stream, for example, that carries data pertaining to multimedia content that is transmitted from one or more content servers to a media device, as discussed above with respect to FIG. 3.

At step 720, the process 700 includes establishing a connection with a first audio device associated with a first user. And at step 730, the process 700 includes establishing a connection with a second audio device associated with a second user. Audio devices associated with the first/second users can be wireless (or wired) headphone devices, such as a conduction headphone device, that is configured for delivering personalized audio to the corresponding user, e.g., without audibly interfering with other users in the same vicinity.

At step 740, the process 700 includes delivering a first segment of the audio stream to the first user, via the first audio device. The audible content selected for the first audio stream can be based on one or more user preferences for the first user, such as language preferences, mature content filtering preferences, audio preferences, and the like.

At step 750, the process 700 includes delivering a second segment of the audio stream to the second user, via the second audio device. As discussed above, delivering customized audio streams to each user can allow the first user and the second user to experience personalized audio streams tailored to their individual preferences or needs, without interfering with each other's listening experience.

### Example Computer System

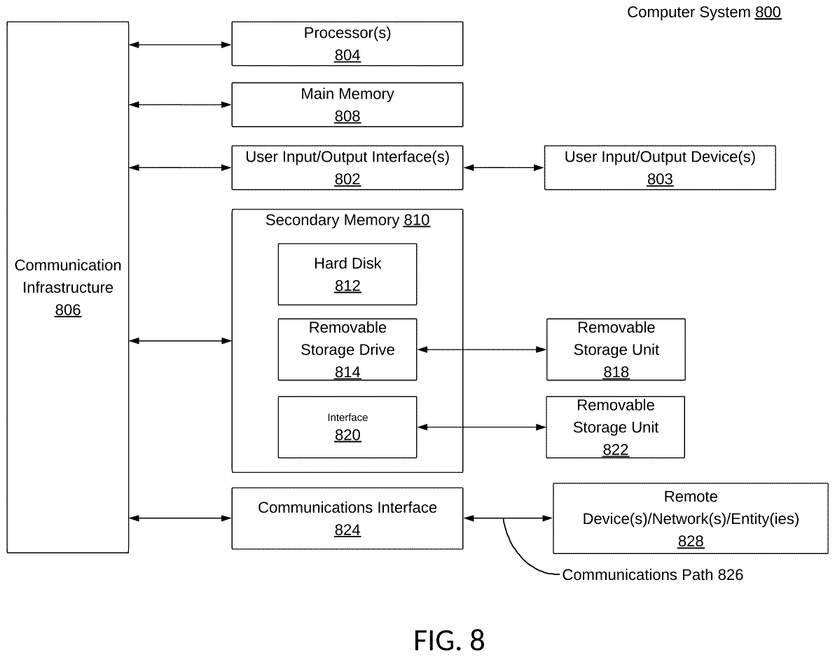

Various aspects and examples may be implemented, for example, using one or more well-known computer systems, such as computer system 800 shown in FIG. 8. For example, the media device 106 may be implemented using combinations or sub-combinations of computer system 800. Also or alternatively, one or more computer systems 800 may be used, for example, to implement any of the aspects and examples discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU). In some examples, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (e.g., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 800 may include a communication or network interface 824. Communication interface 824 may enable computer system 800 to communicate and interact with any combination of external devices, external networks, external entities, etc. (individually and collectively referenced by reference number 828). For example, communication interface 824 may allow computer system xx00 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some examples, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800 or processor(s) 804), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 9. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined if the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

### Illustrative Examples of the Disclosure Include:

Aspect 1. An apparatus for comprising: at least one memory; and at least one processor coupled to the at least one memory, the at least one processor configured to perform operations for: receiving an audio stream; establishing a connection with a first audio device associated with a first user; establishing a connection with a second audio device associated with a second user; delivering a first segment of the audio stream to the first audio device based on user preferences associated with the first user; and delivering a second segment of the audio stream to the second audio device based on user preferences associated with the second user.

Aspect 2. The apparatus of Aspect 1, wherein the at least one processor is configured to: deliver a third segment of the audio stream to the first audio device and the second audio device.

Aspect 3. The apparatus of any of Aspects 1 to 2, wherein the first segment of the audio stream corresponds with audio content of a first language, and wherein the second segment of the audio stream corresponds with audio content of a second language.

Aspect 4. The apparatus of any of Aspects 1 to 3, wherein the first segment of the audio stream is based on a mature language filter associated with a user profile for the first user.

Aspect 5. The apparatus of any of Aspects 1 to 4, wherein delivering the first segment of the audio stream to the first audio device further comprises: amplifying one or more frequencies associated with the first segment of the audio stream based on the user preferences associated with the first user.

Aspect 6. The apparatus of any of Aspects 1 to 5, wherein delivering the first segment of the audio stream to the first audio device further comprises: attenuating one or more frequencies associated with the first segment of the audio stream based on the user preferences associated with the first user.

Aspect 7. The apparatus of any of Aspects 1 to 6, wherein the first segment of the audio stream comprises audio descriptions associated with visual content corresponding with the audio stream.

Aspect 8. A computer-implemented method comprising: receiving an audio stream; establishing a connection with a first audio device associated with a first user; establishing a connection with a second audio device associated with a second user; delivering a first segment of the audio stream to the first audio device based on user preferences associated with the first user; and delivering a second segment of the audio stream to the second audio device based on user preferences associated with the second user.

Aspect 9. The computer-implemented method of Aspect 8, further comprising: delivering a third segment of the audio stream to the first audio device and the second audio device.

Aspect 10. The computer-implemented method of any of Aspects 8 to 9, wherein the first segment of the audio stream corresponds with audio content of a first language, and wherein the second segment of the audio stream corresponds with audio content of a second language.

Aspect 11. The computer-implemented method of any of Aspects 8 to 10, wherein the first segment of the audio stream is based on a mature language filter associated with a user profile for the first user.

Aspect 12. The computer-implemented method of any of Aspects 8 to 11, wherein delivering the first segment of the audio stream to the first audio device further comprises: amplifying one or more frequencies associated with the first segment of the audio stream based on the user preferences associated with the first user.

Aspect 13. The computer-implemented method of any of Aspects 8 to 12, wherein delivering the first segment of the audio stream to the first audio device further comprises: attenuating one or more frequencies associated with the first segment of the audio stream based on the user preferences associated with the first user.

Aspect 14. The computer-implemented method of any of Aspects 8 to 13, wherein the first segment of the audio stream comprises audio descriptions associated with visual content corresponding with the audio stream.

Aspect 15. A non-transitory computer-readable storage medium comprising at least one instruction for causing a computer or processor to: receive an audio stream; establish a connection with a first audio device associated with a first user; establish a connection with a second audio device associated with a second user; deliver a first segment of the audio stream to the first audio device based on user preferences associated with the first user; and deliver a second segment of the audio stream to the second audio device based on user preferences associated with the second user.

Aspect 16. The non-transitory computer-readable storage medium of Aspect 15, wherein the at least one instruction is further configured to cause the processor or computer to: deliver a third segment of the audio stream to the first audio device and the second audio device.

Aspect 17. The non-transitory computer-readable storage medium of any of Aspects 15 to 16, wherein the first segment of the audio stream corresponds with audio content of a first language, and wherein the second segment of the audio stream corresponds with audio content of a second language.

Aspect 18. The non-transitory computer-readable storage medium of any of Aspects 15 to 17, wherein the first segment of the audio stream is based on a mature language filter associated with a user profile for the first user.

Aspect 19. The non-transitory computer-readable storage medium of any of Aspects 15 to 18, wherein to deliver the first segment of the audio stream, the at least one instruction is further configured to cause the processor or computer to: amplify one or more frequencies associated with the first segment of the audio stream based on the user preferences associated with the first user.

Aspect 20. The non-transitory computer-readable storage medium of any of Aspects 15 to 19, wherein to deliver the first segment of the audio stream, the at least one instruction is further configured to cause the processor or computer to: attenuate one or more frequencies associated with the first segment of the audio stream based on the user preferences associated with the first user.

What is claimed is:

1. An apparatus for comprising:
at least one memory; and
at least one processor coupled to the at least one memory, the at least one processor configured to perform operations for:
receiving an audio stream;
establishing a connection with a first audio device associated with a first user;
establishing a connection with a second audio device associated with a second user;
delivering a first segment of the audio stream to the first audio device based on user preferences associated with the first user; and
delivering a second segment of the audio stream to the second audio device based on user preferences associated with the second user.

2. The apparatus of claim 1, wherein the at least one processor is configured to:
deliver a third segment of the audio stream to the first audio device and the second audio device.

3. The apparatus of claim 1, wherein the first segment of the audio stream corresponds with audio content of a first language, and wherein the second segment of the audio stream corresponds with audio content of a second language.

4. The apparatus of claim 1, wherein the first segment of the audio stream is based on a mature language filter associated with a user profile for the first user.

5. The apparatus of claim 1, wherein delivering the first segment of the audio stream to the first audio device further comprises:
amplifying one or more frequencies associated with the first segment of the audio stream based on the user preferences associated with the first user.

6. The apparatus of claim 1, wherein delivering the first segment of the audio stream to the first audio device further comprises:
attenuating one or more frequencies associated with the first segment of the audio stream based on the user preferences associated with the first user.

7. The apparatus of claim 1, wherein the first segment of the audio stream comprises audio descriptions associated with visual content corresponding with the audio stream.

8. A computer-implemented method comprising:
receiving an audio stream;
establishing a connection with a first audio device associated with a first user;
establishing a connection with a second audio device associated with a second user;
delivering a first segment of the audio stream to the first audio device based on user preferences associated with the first user; and
delivering a second segment of the audio stream to the second audio device based on user preferences associated with the second user.

9. The computer-implemented method of claim 8, further comprising:
delivering a third segment of the audio stream to the first audio device and the second audio device.

10. The computer-implemented method of claim 8, wherein the first segment of the audio stream corresponds with audio content of a first language, and wherein the second segment of the audio stream corresponds with audio content of a second language.

11. The computer-implemented method of claim 8, wherein the first segment of the audio stream is based on a mature language filter associated with a user profile for the first user.

12. The computer-implemented method of claim 8, wherein delivering the first segment of the audio stream to the first audio device further comprises:
amplifying one or more frequencies associated with the first segment of the audio stream based on the user preferences associated with the first user.

13. The computer-implemented method of claim 8, wherein delivering the first segment of the audio stream to the first audio device further comprises:
attenuating one or more frequencies associated with the first segment of the audio stream based on the user preferences associated with the first user.

14. The computer-implemented method of claim 8, wherein the first segment of the audio stream comprises audio descriptions associated with visual content corresponding with the audio stream.

15. A non-transitory computer-readable storage medium comprising at least one instruction for causing a computer or processor to:
receive an audio stream;
establish a connection with a first audio device associated with a first user;
establish a connection with a second audio device associated with a second user;
deliver a first segment of the audio stream to the first audio device based on user preferences associated with the first user; and
deliver a second segment of the audio stream to the second audio device based on user preferences associated with the second user.

16. The non-transitory computer-readable storage medium of claim 15, wherein the at least one instruction is further configured to cause the processor or computer to:
deliver a third segment of the audio stream to the first audio device and the second audio device.

17. The non-transitory computer-readable storage medium of claim 15, wherein the first segment of the audio stream corresponds with audio content of a first language, and wherein the second segment of the audio stream corresponds with audio content of a second language.

18. The non-transitory computer-readable storage medium of claim 15, wherein the first segment of the audio stream is based on a mature language filter associated with a user profile for the first user.

19. The non-transitory computer-readable storage medium of claim 15, wherein to deliver the first segment of the audio stream, the at least one instruction is further configured to cause the processor or computer to:
amplify one or more frequencies associated with the first segment of the audio stream based on the user preferences associated with the first user.

20. The non-transitory computer-readable storage medium of claim 15, wherein to deliver the first segment of the audio stream, the at least one instruction is further configured to cause the processor or computer to:
attenuate one or more frequencies associated with the first segment of the audio stream based on the user preferences associated with the first user.
